(19) United States
(12) Patent Application Publication
(10) Pub. No.: US 2006/0087613 A1
(43) Pub. Date: Apr. 27, 2006

(54) Liquid crystal display, and method for repairing defective pixels of liquid crystal display

(76) Inventors: Ryuichi Togawa, Machida-shi (JP); Yoshitaka Kawada, Tokyo (JP); Kenta Fukatsu, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/234,190

(22) Filed: Sep. 26, 2005

(30) Foreign Application Priority Data
Sep. 27, 2004 (JP) 2004-279465

(51) Int. Cl. G02F 1/13

(52) U.S. Cl. 349/192

(57) ABSTRACT

A defective-pixel repairing method is applied to a liquid crystal display. The method applies pulse laser beam to a signal line adjacent to a defective pixel, so as to generate an air bubble. The air bubble is to cover substantially the entirety of the defective pixel and is located at the position corresponding to the defective pixel. The method also applies pulse laser beam to substantially the entirety of the defective pixel where the air bubble is generated, thereby repairing the defective pixel.

### CROSS-REFERENCE TO RELATED APPLICATIONS

This application is based upon and claims the benefit of priority from prior Japanese Patent Application No. 2004-279465, filed Sep. 27, 2004, the entire contents of which are incorporated herein by reference.

### BACKGROUND OF THE INVENTION

1. Field of the Invention

The present invention relates to a liquid crystal display and a method for repairing defective pixels of the liquid crystal display by the irradiation of pulse laser beam.

2. Description of the Related Art

A liquid crystal display comprises an array substrate and a counter substrate. The array substrate and the counter substrate face each other and are spaced from each other by a predetermined distance by a spacer. A liquid crystal material fills the space between the array substrate and the counter substrate.

The array substrate comprises pixel electrodes, signal lines, TFTs, and gate lines on the inner surface thereof. The pixel electrodes are used for applying an aligning voltage to the liquid crystal material. The signal lines are used for electrically charging or discharging the pixel electrodes. The TFTs are used for switching between the conducted state and the nonconducted state of the signal lines and the pixel electrodes. The gate lines are used for driving the TFTs. The array substrate also comprises an alignment film which is located at a position closest to the counter substrate and which is used for aligning the liquid crystal material.

The counter substrate comprises color filters and transparent electrodes on the inner surface thereof. The color filters are RGB filters used for backlight. The transparent electrodes are used for applying an aligning voltage to the liquid crystal material. The counter substrate also comprises an alignment film which is located at a position closest to the array substrate and which is used for aligning the liquid crystal material.

In accordance with an increase in the size of screens and an increase in the resolutions they have, how to prevent defects is an important problem in the manufacturing process of liquid crystal displays. Among the defects, a pixel whose TFT does not function and a pixel whose liquid crystal cannot be aligned, are defects that have to be reduced by any means. If such defects are caused, the liquid crystal material does intercept the backlight, and a related pixel (which is a defective pixel) is regarded as a “bright defect.”

Since the “bright defects” significantly lower the display performance of the liquid crystal displays, the reduction of the “bright defects” is tried by choosing desirable design values and properly determining the conditions under which the manufacturing process is carried out. However, reducing the bright defects by this approach has limitations, and the bright defects cannot be completely eliminated.

Under the circumstances, liquid crystal displays are manufactured first, and then the manufactured liquid crystal displays are checked to see whether “bright defects” are present on them. If there are “bright defects,” they are repaired one by one.

As a method for repairing a defective pixel of a liquid crystal display, it is irradiated with pulse laser beams to process the alignment films and transparent electrode. By processing these, the amount of light transmitted through the defective pixel is reduced, thereby making the “bright defects” less conspicuous (see Jpn. Pat. Appln. KOKAI Publication No. 8-15660).

The amount of light transmitted through the defective pixel can be reduced by the irradiation of pulse laser beams. This is because the alignment films and transparent electrode are processed by the energy of the pulse laser beams, and the fine particles generated by this processing are deposited on the inner surface of the defective pixel.

Where fine particles are deposited on the inner surfaces of the defective pixel, the alignment characteristic the alignment films have on the liquid crystal material is degraded, the liquid crystal molecules constituting the liquid crystal material may not align. As a result, the amount of light transmitted through the defective pixel decreases. If an air bubble is not present, the processed surfaces may not be uniform, and the amount of light transmitted may not be sufficiently.

In the inner surface of a conventional glass substrate, there is a step between the adjacent pixels. Because of this step, the air bubble generated by the irradiation of the pulse laser beams can remain in the target pixel (i.e., at the position of the defective pixel).

In recent years, however, a so-called flat substrate, which is a glass substrate having a flat inner surface, is sometimes used for the purpose of ensuring reliable alignment of liquid crystal materials. Since the flat substrate does not have a step between the adjacent pixels, the air bubble generated by the irradiation of the pulse laser beams may move to regions located around a defective pixel. If this happens, no air bubble may exist at the position to be processed by the subsequent irradiation of the pulse laser beams.

In recent years, moreover, thin transparent electrodes are employed so as to enhance the optical transmittance of the opening section of a pixel, and the brightness and contrast characteristics of the liquid crystal display are intended by the enhancement of the optical transmittance. Where the transparent electrodes are thin, the amount of fine particles generated by the irradiation of the pulse laser beams decreases. In the conventional defective-pixel repairing method, it may not be easy to sufficiently reduce the amount of light transmitted through a defective pixel.

### BRIEF SUMMARY OF THE INVENTION

The present invention may provide a liquid crystal display and a defective-pixel repairing method, wherein an air bubble is present at the position of a pixel irradiated with pulse laser beam and a defective pixel can repaired reliably.

According to one aspect of the present invention, there is provided a defective-pixel repairing method which is applied to a liquid crystal display and which comprises: applying pulse laser beam to a signal line adjacent to a defective pixel, thereby generating an air bubble to cover substantially the entirety of the defective pixel such that the air bubble is in a liquid crystal material and located at a position corresponding to the defective pixel; and applying pulse laser beam to substantially the entirety of the defective pixel where the air bubble is generated, thereby repairing the defective pixel.

According to another aspect of the present invention, there is provided a defective-pixel repairing method which is applied to a liquid crystal display and which comprises: applying pulse laser beam to a gate line adjacent to a defective pixel, thereby generating an air bubble to cover substantially the entirety of the defective pixel such that the air bubble is in a liquid crystal material and located at a position corresponding to the defective pixel; and applying pulse laser to substantially the entirety of the defective pixel where the air bubble is generated, thereby repairing the defective pixel.

According to still another aspect of the present invention, there is provided a liquid crystal display comprising: two substrates facing each other with a liquid crystal material interposed therebetween; a pixel electrode arranged on a given one of the two substrates and configured to apply an aligning voltage to the liquid crystal material; a signal line provided on the given one of the two substrates and configured to electrically charge or discharge the pixel electrode; a TFT provided on the given one of the two substrates, and switching between a conducted state and a nonconducted state of the pixel electrode and the signal line by being applied with a driving voltage;

a gate line provided on the given one of the two substrates and configured to apply the driving voltage to the TFT; and a target configured to generate an air bubble in the liquid crystal material when irradiated with pulse laser beam.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a partially-sectional view of a liquid crystal display according to a first embodiment of the present invention.

FIG. 2 is a schematic diagram illustrating pixels according to a first embodiment.

FIG. 3 is an explanatory diagram illustrating the process of repairing a defective pixel

FIG. 4 is a partially-sectional view of a liquid crystal display according to a second embodiment of the present invention.

FIG. 5 is a schematic diagram illustrating pixels according to a second embodiment.

FIG. 6 is a partially-sectional view of a liquid crystal display according to a modification of a second embodiment.

FIG. 7 is a partially-sectional view of a liquid crystal display according to a third embodiment of the present invention.

FIG. 8 is a schematic diagram illustrating pixels according to a third embodiment.

### DETAILED DESCRIPTION OF THE INVENTION

A first to third embodiments of the present invention will now be described in detail with reference to the accompanying drawings.

### A First Embodiment

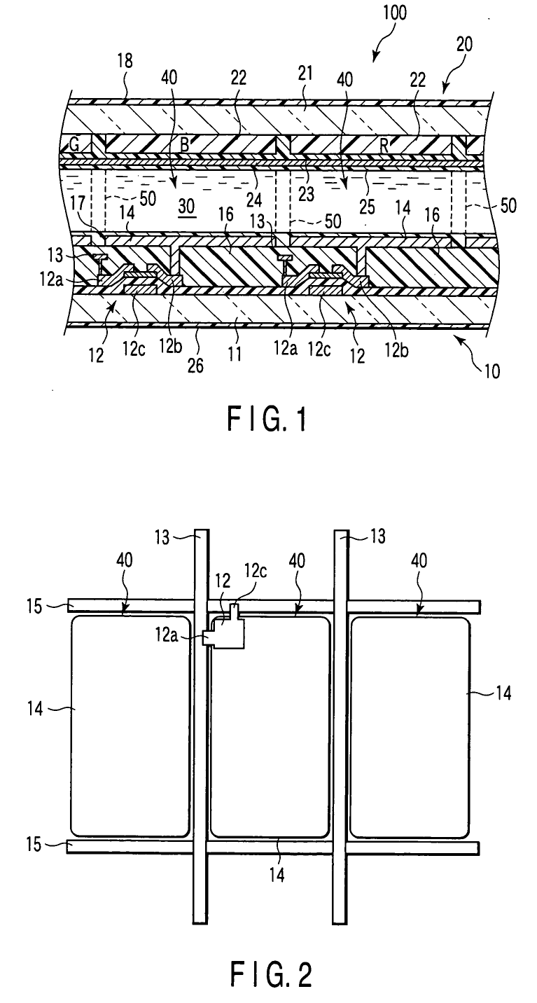

The first embodiment will be described first, referring to FIGS. 1-3.

FIG. 1 is a partially-sectional view of a liquid crystal display according to the first embodiment of the present invention. FIG. 2 is a schematic diagram illustrating pixels used in the first embodiment.

As shown in FIGS. 1 and 2, the liquid crystal display 100 of the embodiment comprises an array substrate 10, a counter substrate 20 and a liquid crystal material 30. In the region to be used as a display screen of the liquid crystal display 100, a plurality of pixels 40 are arranged in a matrix pattern.

The array substrate 10 and the counter substrate 20 face each other, with spacers 50 sandwiched therebetween. The liquid crystal material 30 is sealed between the array substrate 10 and the counter substrate 20. The spacers 50 are shaped like columns or spheres and are arranged at the intersections of signal lines 13 (to be mentioned later) and gate lines 15 (to be mentioned later). Normally, the spacers 50 are formed of black resin or non-alkali glass.

The array substrate 10 includes a transparent glass substrate 11, and thin film transistors (hereinafter referred to as “TFTs”) 12 are formed on the inner surface of the transparent glass substrate 11. The TFTs 12 are provided for the respective pixels 40 and switch the signal lines 13 and pixel electrodes 14 between the conductive state and the nonconductive state. Each TFT 12 has a source electrode 12a, a drain electrode 12b and a gate electrode 12c.

The signal lines 13, which are used for electrically charging or discharging the pixel electrodes 14, are connected to the source electrodes 12a. The pixel electrodes 14, which are used for applying an aligning voltage to the liquid crystal material 30, are connected to the drain electrodes 12b. The gate lines 15, which apply a driving voltage to the TFT 12, are connected to the gate electrodes 12c.

The signal lines 13 and the gate lines 15 are provided on the inner surface of the glass substrate 11. The signal and gate lines 13 and 15 form a lattice structure wherein each pixel electrode 14 is surrounded in a plan view. The signal and gate lines 13 and 15 are formed of Al alloy or Mo alloy.

A thick insulating film 16 is formed on the TFTs 12, signal lines 13 and gate lines 15. The pixel electrodes 14 are located on this thick insulating film 16 and arranged at positions corresponding to the pixels 40. An alignment film 17 is formed to cover the pixel electrodes 14 and the insulating film 16.

As can be seen from the above, the TFTs 12, the gate lines 15, the signal lines 13 and pixel electrodes 14 are formed in the order mentioned, from the glass substrate 11. The pixel electrodes 14 are formed of indium tin oxide (ITO), and the alignment film 17 is formed of polyimide (PI). A polarizing plate 18 is attached to the outer surface of the glass substrate 11 so as to allow transmission of only predetermined polarized light.

Like the array substrate 10, the counter substrate 20 includes a transparent glass substrate 21. Color filters 22 of “R” (red), “G” (green) and “B” (blue) are arranged on the inner surface of the glass substrate 21 in such a manner that they are located at positions corresponding to the pixel electrodes 14. A protective film 23, a conductive thin film 24 and an alignment film 25 are formed on the color filters 22 in the order mentioned. The conductive thin film 24 is formed of indium tin oxide (ITO), and the alignment film 25 is formed of polyimide (PI). A polarizing plate 26 is attached to the outer surface of the glass substrate 21 so as to allow transmission of only predetermined polarized light.

The pixels 40 of the liquid crystal display 100 having the above configuration may include a defective pixel G which looks bright irrespective of the driving by the TFTs 12. The method which the first embodiment of the present invention employs to repair the defective pixel G decreases the amount of light transmitted through the defective pixel G, thereby making the defective pixel G less conspicuous.

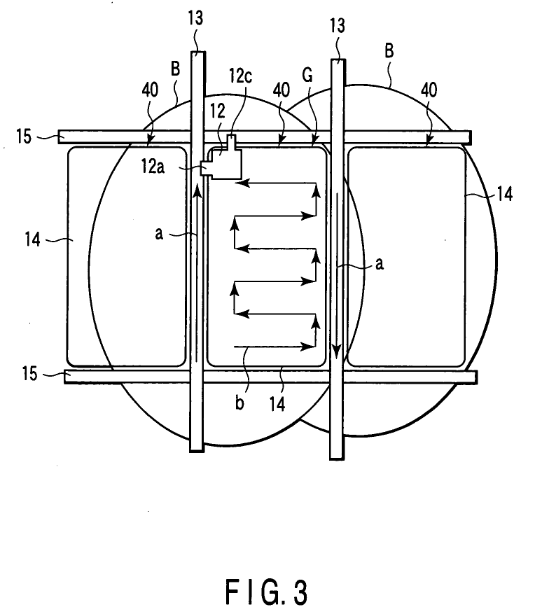

How to repair the defective pixel G of the above liquid crystal display 100 will now be described, referring to FIG. 3.

FIG. 3 is an explanatory diagram illustrating the process of repairing the defective pixel G.

When the defective pixel G is detected, the signal lines 13 adjacent to the defective pixel G and/or the gate lines 15 adjacent to the defective pixel G is irradiated with pulse laser beams L. In the first embodiments, the two signal lines 13 are irradiated with the pulse laser beams L. Preferably, the energy of each pulse laser beam L is 0.2 to 0.3 J/P.

When the signal lines 13 are irradiated with the pulse laser beams L, the energy of the pulse laser beams L heats the signal lines 13, so that an air bubble is generated in the liquid crystal material at a position in the neighborhood of the irradiation position of the pulse laser beams L. The air bubble increases in volume in accordance with an increase in the number of times the pulse laser beams L are applied. After a predetermined period of time, the air bubble becomes large enough to cover the defective pixel G.

As indicated by arrows “a” in FIG. 3, the pulse laser beam L is moved along the signal lines 13. By gradually moving the irradiation position, the air bubble B assumes a desired position with respect to the defective pixel G. Thus, defective pixel G can be covered with an air bubble B of minimum size.

After defective pixel G is covered with air bubble B, the defective pixel is entirely scanned with the pulse laser beams L as indicated by arrows “b”. This scanning operation has to be carried out before air bubble B disappears. As a result of the scanning operation, the alignment films 17 and 25, the pixel electrodes 14, the color filters 22 and the conductive thin film 24 are processed, and fine particles are generated at positions surrounding the irradiation position of the pulse laser beams L.

As described above, the air bubble B larger than the defective pixel G is present in the liquid crystal material 30 at the position corresponding to the defective pixel G. Therefore, the fine particles produced by irradiation of the pulse laser beams L are dispersed in the air bubble B without being obstructed by the liquid crystal material 30. The fine particles are deposited on the inner surfaces of the array substrate 10 and counter substrate 20 and form a thick and uniform layer. Hence, the aligning effect the alignment films 17 and 25 have on the liquid crystal material 30 decreases, and the defective pixel G becomes a dark defect.

As described above, in the method which the first embodiment provides to repair the defective pixel of the liquid crystal display 100, pulse laser beams L are applied to the signal lines 13 before it is applied to the defective pixel G. By applying pulse laser beams L in this manner, air bubble B large enough to cover defective pixel G is generated in the liquid crystal material 30 at the position corresponding to the defective pixel G.

When the alignment films 17 and 25, the pixel electrodes 14 and the conductive thin film 24 are processed thereafter, air bubble B never fails to exist at the irradiation position of pulse laser beams L. Therefore, the defective pixel G never fails to become a dark defect.

The signal lines which pulse laser beams L are applied to is made of a metallic material. Since, therefore, air bubble B becomes sufficiently large in a very short period of time, the time required for repairing the defective pixel can be significantly shortened.

### A Second Embodiment

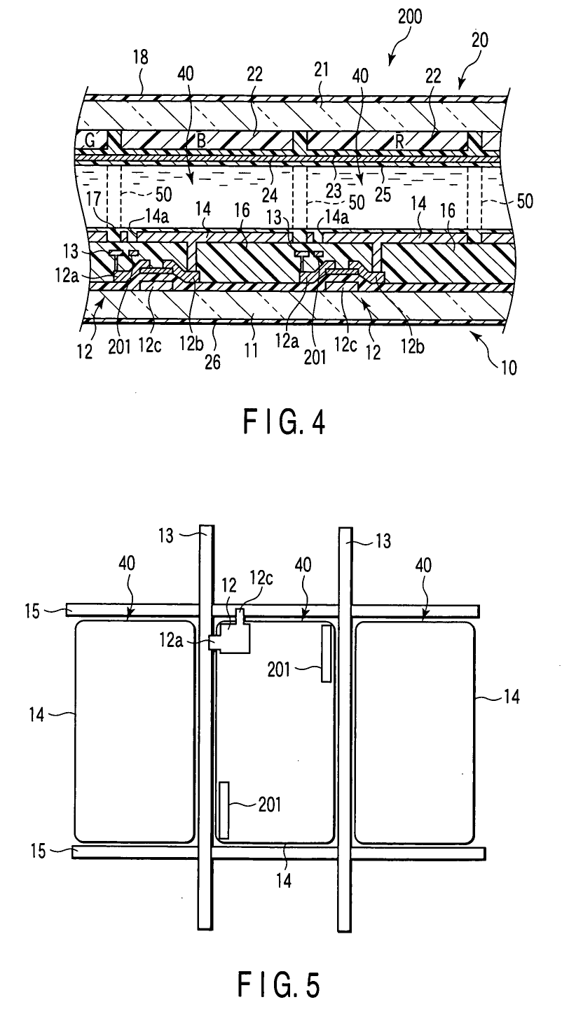

The second embodiment of the present invention will now be described, referring to FIGS. 4 and 5. For the sake of simplicity, no description will be given of those structures and operations which are similar to those of the first embodiment.

FIG. 4 is a partially-sectional view of a liquid crystal display according to the second embodiment of the present invention. FIG. 5 is a schematic diagram illustrating pixels according to the second embodiment.

As shown in FIGS. 4 and 5, the liquid crystal display 200 of the second embodiment differs from that (100) of the first embodiment in that air generation pads 201 are additionally used. The air generation pads 201 are heated by irradiation of pulse laser beams L and generate air bubble B in the liquid crystal material 30.

The air generation pads 201 are like thin films. They are in the same plane as the signal lines 13 and arranged at positions corresponding to the pixel electrodes 14 in such a manner that they are close to the signal lines 13 or gate lines 15. The air generation pads 201 are made of the same material as the signal lines 13 and gate lines 15. For example, they are made of Al alloy or Mo alloy.

Each pixel electrode 14 has an opening 14a at the position corresponding to an air generation pad 201. After passing through the opening 14a, pulse laser beams L are incident on the air generation pad 201.

How to repair the defective pixel G of the liquid crystal display 200 will now be described.

When the defective pixel G is detected, the air generation pad 201 corresponding to the detected defective pixel G is irradiated with pulse laser beams L. As a result, the air generation pad 201 is heated, and an air bubble is generated in the liquid crystal material 30 at a position corresponding to defective pixel G.

The air bubble increases in volume in accordance with an increase in the number of times pulse laser beams L are applied. After a predetermined period of time, the air bubble becomes large enough to cover the defective pixel G. The energy of each pulse laser beam L to be applied to the air generation pad 201 is preferably in the range of 0.2 to 0.3 J/P, but may take a value greater than this range.

After defective pixel G is covered with air bubble B, the defective pixel G is entirely scanned with pulse laser beams L. This scanning operation has to be carried out before air bubble B disappears. As a result of the scanning operation, the alignment films 17 and 25, the pixel electrodes 14, the color filters 22 and the conductive thin film 24 are processed, and fine particles are generated at positions surrounding the irradiation position of pulse laser beams L.

As described above, the air bubble B larger than the defective pixel G is present in the liquid crystal material 30 at the position corresponding to the defective pixel G. Therefore, the fine particles produced by irradiation of the pulse laser beams L are dispersed in the air bubble B without being obstructed by the liquid crystal material 30. The fine particles are deposited on the inner surfaces of the array substrate 10 and counter substrate 20 and form a thick and uniform layer. Hence, the orientation effect the alignment films 17 and 25 have on the liquid crystal material 30 decreases, and the defective pixel G becomes a dark defect.

As described above, the liquid crystal display 200 of the second embodiment comprises air generation pad 201 provided for each of the pixels 40. By applying pulse laser beams L to the air generation pad 201, air bubble B large enough to cover defective pixel G is generated in the liquid crystal material 30 at the position corresponding to the defective pixel G.

With this structure, the signal lines 13 and the gate lines 15, which are important to the liquid crystal display 200, are not exposed to pulse laser beams L. Therefore, high-energy pulse laser beams L can be used without consideration of the damage to the signal lines 13 and the gate line 15. Since the use of the high-energy pulse laser beams L shortens the time required for generating air bubble B, the time required for repairing the defective pixel G can be shortened, accordingly.

The air generation pads 201 are in the same plane as the signal lines 13 and are made of the same material as the signal lines 13. Since, therefore, the air generation pads 201 can be formed in the same step as the signal lines 13, the additional use of the air generation pads 201 does not complicate the manufacturing process of the liquid crystal display 200.

In addition, the air generation pads 201 are located close to the signal lines 13 and/or gate lines 15. With this structure, the use of the air generation pads 201 does not significantly decrease the aperture ratio. The decrease in the aperture ratio is a minimum.

In the second embodiment, the air generation pads 201 are in the same plane as the signal lines 13. Although the present invention is not limited to this structure, it is desirable to provide the air generation pads 201 in the same plane as the signal lines 13 and/or the gate lines 15. Where the air generation pads 201 are provided in this manner, the air generation pads 201 can be made in the same step as the signal lines 13 and/or gate lines 15, thus simplifying the manufacturing process of the liquid crystal display.

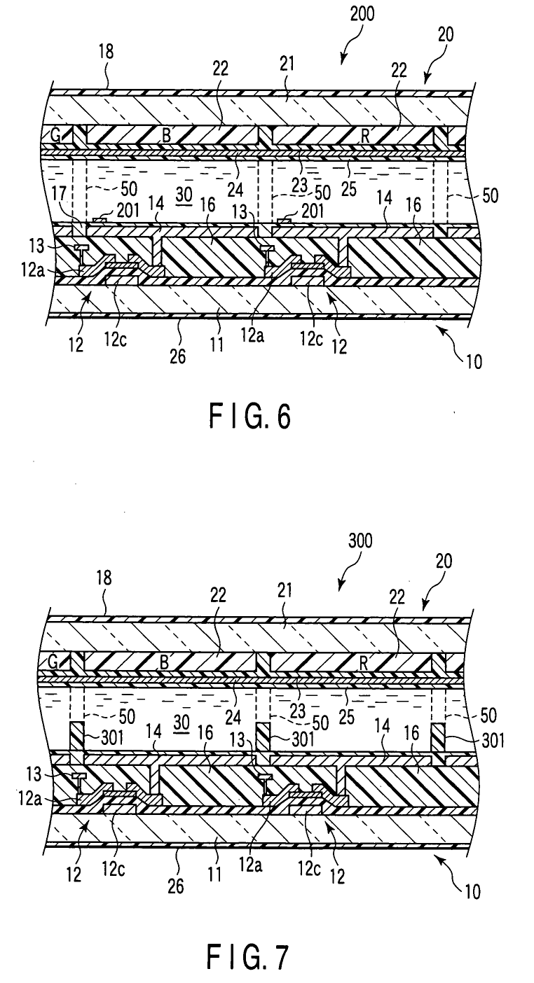

In the second embodiment, the air generation pads 201 are formed on those surfaces of the pixel electrodes 14 which face the glass substrate 11. As shown in FIG. 6, however, the air generation pads may be formed in contact with the liquid crystal material 30. Where this structure is adopted, the heat generated when the air generation pads 201 are irradiated with pulse laser beams L can be transmitted to the liquid crystal material 30 with high efficiency. Accordingly, the time required for generating air bubble B in the liquid crystal material 30 is shortened.

In the second embodiment, the air generation pads 201 are made of the same material as the signal lines 13 and gate lines 15. However, the present invention is not limited to this structure. The air generation pads 201 may be made of any material, as long as the material can be heated in a short time upon irradiation of pulse laser beams L and is hard to damage.

### A Third Embodiment

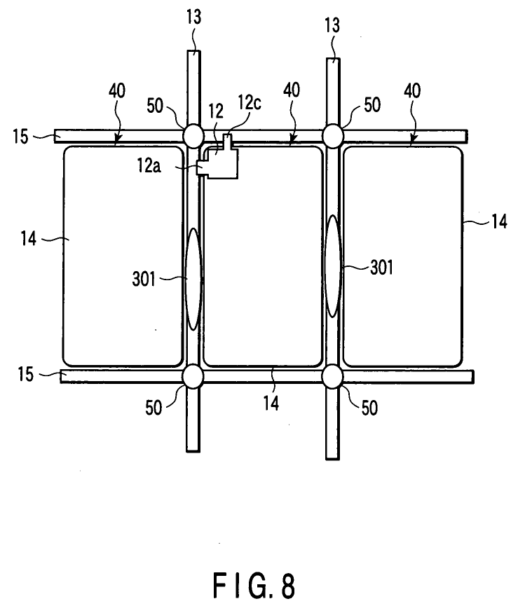

The third embodiment of the present invention will now be described, referring to FIGS. 7 and 8. For the sake of simplicity, no description will be given of those structures and operations which are similar to those of the first and second embodiments.

FIG. 7 is a partially-sectional view of a liquid crystal display according to the third embodiment of the present invention. FIG. 8 is a schematic diagram illustrating pixels used in the third embodiment.

As shown in FIGS. 7 and 8, the liquid crystal display 300 of the third embodiment differs from that (100) of the first embodiment in that air generation projections 301 are additionally used. The air generation projections 301 are heated by irradiation of pulse laser beams L and generate air bubble B in the liquid crystal material 30.

The air generation projections 301 are at positions corresponding to the signal lines 13 of the array substrate 10 and protrude toward the counter substrate 20. The air generation projections 301 have end faces opposed to the counter substrate 20, and the defined between the counter substrate 20 and the end faces of the air generation projections 301 is filled with a liquid crystal material 30. The air generation projections 301 are formed of the same material as the spacers 50; they are formed of black resin or non-alkali glass.

In the third embodiment, the air generation projections 301 are provided at positions corresponding to the signal lines 13 of the array substrate 10. With this structure, the pixels 40 of the third embodiment provide a higher aperture ratio than the pixels of the second embodiment.

In addition, the liquid crystal material 30 is located between the air generation projections 301 and the counter substrate 20. With this structure, the contact area between the air generation projections 301 and the liquid crystal material is increased, and the heat generated when the air generation projections 301 are irradiated with pulse laser beams L can be transmitted to the liquid crystal material 30 with high efficiency. Accordingly, the time required for generating air bubble B in the liquid crystal material 30 can be shortened, and the time required for repairing the defective pixel G can be shortened.

In the third embodiment, the air generation projections 301 are formed of the same material as the spacers 50. Since the air generation projections and the spacers 50 can be formed simultaneously, the additional use of the air generation projections 301 of the third embodiment does not complicate the manufacturing process of the liquid crystal display 300.

It should be noted that the air generation projections 301 and the spacers 50 are made of black materials. Since, therefore, the air generation protections 301 are efficiently heated by irradiation of pulse laser beams L, air bubble B can be generated in a short time in the liquid crystal material 30 at the position corresponding to defective pixel G.

The present invention is not limited to the embodiments described above, and can be modified in various ways without departing from the spirit and scope of the invention. Moreover, the structural elements of the above embodiments can be selectively combined to make various inventions. For example, some structural elements may be deleted from each embodiment, and structural elements of different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A defective-pixel repairing method applied to a liquid crystal display, comprising:
applying pulse laser beam to a signal line adjacent to a defective pixel, thereby generating an air bubble to cover substantially entirety of the defective pixel such that the air bubble is in a liquid crystal material and located at a position corresponding to the defective pixel; and
applying pulse laser beam to substantially the entirety of the defective pixel where the air bubble is generated, thereby repairing. the defective pixel.

2. The method according to claim 1, wherein the defective pixel is repaired by applying the pulse laser beam to a position where the air bubble is present.

3. The method according to claim 1, wherein the pulse laser beam applied such that an irradiation position moves along the signal line.

4. A defective-pixel repairing method applied to a liquid crystal display, comprising:
applying pulse laser beam to a gate line adjacent to a defective pixel, thereby generating an air bubble to cover substantially entirety of the defective pixel such that the air bubble is in a liquid crystal material and located at a position corresponding to the defective pixel; and
applying pulse laser beam to substantially the entirety of the defective pixel where the air bubble is generated, thereby repairing the defective pixel.

5. The method according to claim 4, wherein the defective pixel is repaired by applying the pulse laser beam to a position where the air bubble is present.

6. The method according to claim 5, wherein the pulse laser beam applied such that an irradiation position moves along the gate line.

7. A liquid crystal display comprising:
two substrates facing each other with a liquid crystal material interposed therebetween;
a pixel electrode arranged on a given one of the two substrates and configured to apply an aligning voltage to the liquid crystal material;
a signal line provided on the given one of the two substrates and configured to electrically charge or discharge the pixel electrode;
a TFT provided on the given one of the two substrates, and switching between a conducted state and a nonconducted state of the pixel electrode and the signal line by being applied with a driving voltage;
a gate line provided on the given one of the two substrates and configured to apply the driving voltage to the TFT; and
a target configured to generate an air bubble in the liquid crystal material when irradiated with pulse laser beam.

8. The liquid crystal display according to claim 7, wherein the target is in contact with the liquid crystal material.

9. The liquid crystal display according to claim 7, wherein the target is located at a position corresponding to the pixel electrode.

10. The liquid crystal display according to claim 9, wherein the target is located close to at least one of the signal line and the gate line.

11. The liquid crystal display according to claim 7, wherein the target includes a metallic material.

12. The liquid crystal display according to claim 7, wherein the target includes a material identical to that of the signal line.

13. The liquid crystal display according to claim 12, wherein the target is formed simultaneously with the signal line.

14. The liquid crystal display according to claim 7, wherein the target includes a material identical to that of the gate line.

15. The liquid crystal display according to claim 14, wherein the target is formed simultaneously with the gate line.

16. The liquid crystal display according to claim 7, wherein the target is located at a position corresponding to at least one of the signal line and the gate line.

17. The liquid crystal display according to claim 7, further comprising:
a spacer provided at a position correspond to the signal line and maintaining a predetermined distance between the two substrates,
the target including a material identical to that of the spacer.

18. The liquid crystal display according to claim 17, wherein the liquid crystal material is interposed between the target and another one of the two substrates.

19. The liquid crystal display according to claim 17, wherein the target includes black resin.

20. The liquid crystal display according to claim 17, wherein the target includes non-alkali glass.
